(19) United States
(12) Patent Application Publication
(10) Pub. No.: US 2018/0035007 A1
(43) Pub. Date: Feb. 1, 2018

(54) IMAGE FORMING APPARATUS, STORAGE MEDIUM, AND METHOD FOR DIGITIZING DOCUMENT

(71) Applicant: KYOCERA Document Solutions Inc., Osaka (JP)

(72) Inventor: Yosuke KASHIMOTO, Osaka (JP)

(73) Assignee: KYOCERA Document Solutions Inc., Osaka (JP)

(21) Appl. No.: 15/657,749

(22) Filed: Jul. 24, 2017

(30) Foreign Application Priority Data
Jul. 28, 2016 (JP) 2016-149068

(51) Int. Cl. H04N 1/387; G06K 9/20; G06K 9/00; H04N 1/00; G06K 9/46

(52) U.S. Cl. CPC H04N 1/3872; H04N 1/00366; H04N 1/00374; H04N 1/00968; G06K 9/4652; G06K 9/00463; G06K 9/2063; H04N 2201/0094; G06K 2209/01

(57) ABSTRACT

An image forming apparatus includes a central processing unit (CPU), a storage device storing a document digitization program, and a reading device that reads an image from an original document. The CPU executes the document digitization program to implement an image acquiring section, an added handwriting extracting section, and a document editing section. The image acquiring section acquires an image of a markup document, which is the original document modified by handwriting, using the reading device. The added handwriting extracting section extracts an added handwriting from the image of the markup document. The document editing section edits a raw original document, which is the original document without the modification, according to a modification instruction given through the added handwriting to generate a digitized document. The document editing section alters a position of at least some of characters and graphics included in the raw original document to generate the digitized document.

### INCORPORATION BY REFERENCE

The present application claims priority under 35 U.S.C. § 119 to Japanese Patent Application No. 2016-149068, tiled on Jul. 28, 2016. The contents of this application are incorporated herein by reference in their entirety.

### BACKGROUND

The present disclosure relates to an image forming apparatus for digitizing a document based on a markup document, which is an original document modified by handwriting. The present disclosure also relates to a storage medium and a method for digitizing a document.

An existing document editing device digitizes a document based on a markup document, which is an original document modified by handwriting.

### SUMMARY

An image forming apparatus according to an aspect of the present disclosure includes a central processing unit (CPU), a storage device, and a reading device. The storage device stores therein a document digitization program. The reading device reads an image from an original document. The CPU executes the document digitization program to implement an image acquiring section, an added handwriting extracting section, and a document editing section. The image acquiring section acquires an image of a markup document using the reading device. The markup document is the original document modified by handwriting. The added handwriting extracting section extracts an added handwriting from the image of the markup document acquired by the image acquiring section. The document editing section edits a raw original document in accordance with a modification instruction given through the added handwriting extracted by the added handwriting extracting section to generate a digitized document. The raw original document is the original document without the modification. The raw original document includes one or more characters and one or more graphics. The document editing section alters a position of at least some of the characters and the graphics included in the raw original document to generate the digitized document.

A non-transitory computer-readable storage medium according to another aspect of the present disclosure stores thereon a document digitization program. The document digitization program causes an image forming apparatus to implement an image acquiring section, an added handwriting extracting section, and a document editing section. The image forming apparatus includes a reading device. The reading device reads an image from an original document. The image acquiring section acquires an image of a markup document using the reading device. The markup document is the original document modified by handwriting. The added handwriting extracting section extracts an added handwriting from the image of the markup document acquired by the image acquiring section. The document editing section edits a raw original document in accordance with a modification instruction given through the added handwriting extracted by the added handwriting extracting section to generate a digitized document. The raw original document is the original document without the modification. The raw original document includes one or more characters and one or more graphics. The document editing section alters a position of at least some of the characters and the graphics included in the raw original document to generate the digitized document.

A method for digitizing a document according to another aspect of the present disclosure is implemented by an image forming apparatus including a reading device. The reading device reads an image from an original document. The method for digitizing a document includes: acquiring an image of a markup document using the reading device, the markup document being the original document modified by handwriting; extracting an added handwriting from the image of the markup document acquired in the acquiring; and altering a position of at least some of one or more characters and one or more graphics included in a raw original document in accordance with a modification instruction given through the extracted added handwriting to generate a digitized document, the raw original document being the original document without the modification.

### BRIEF DESCRIPTION OF THE GRAPHICS

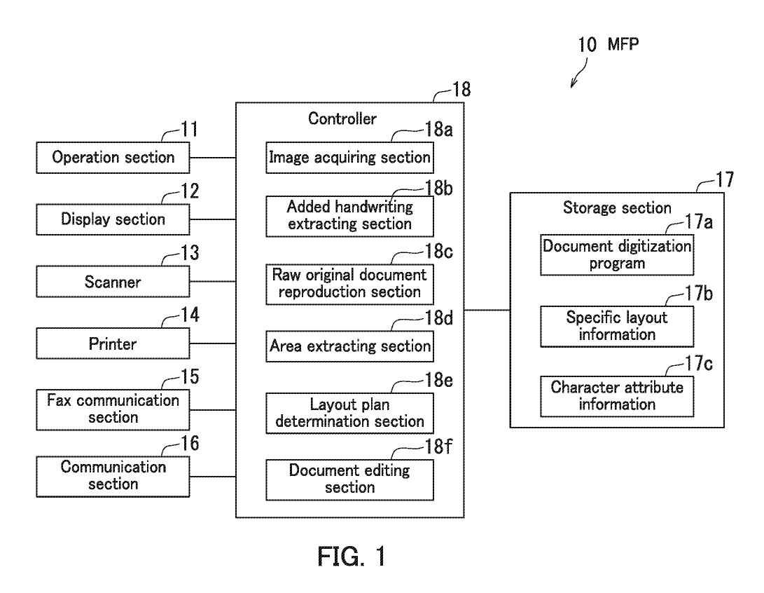

FIG. 1 is a block diagram of a multifunction peripheral (MFP) according to an embodiment of the present disclosure.

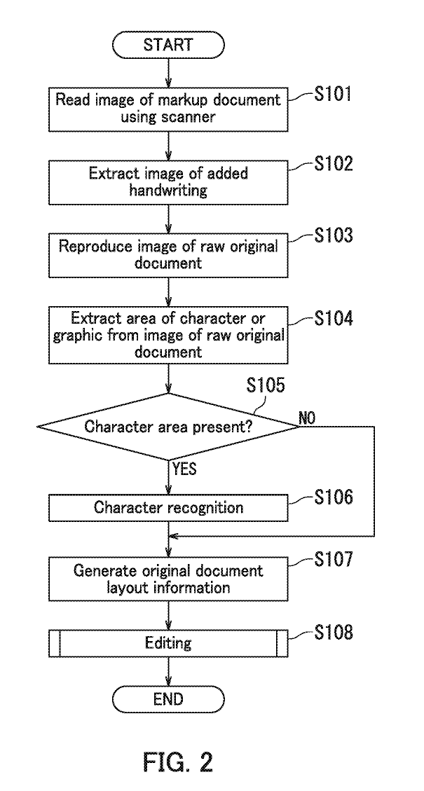

FIG. 2 is a flowchart illustrating operation of the MFP illustrated in FIG. 1 for digitizing a document based on a markup document.

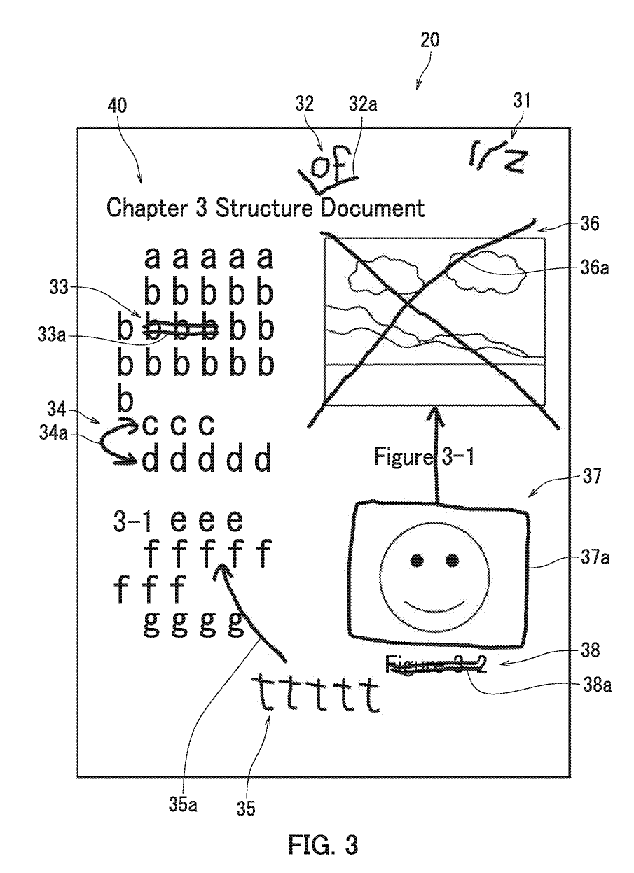

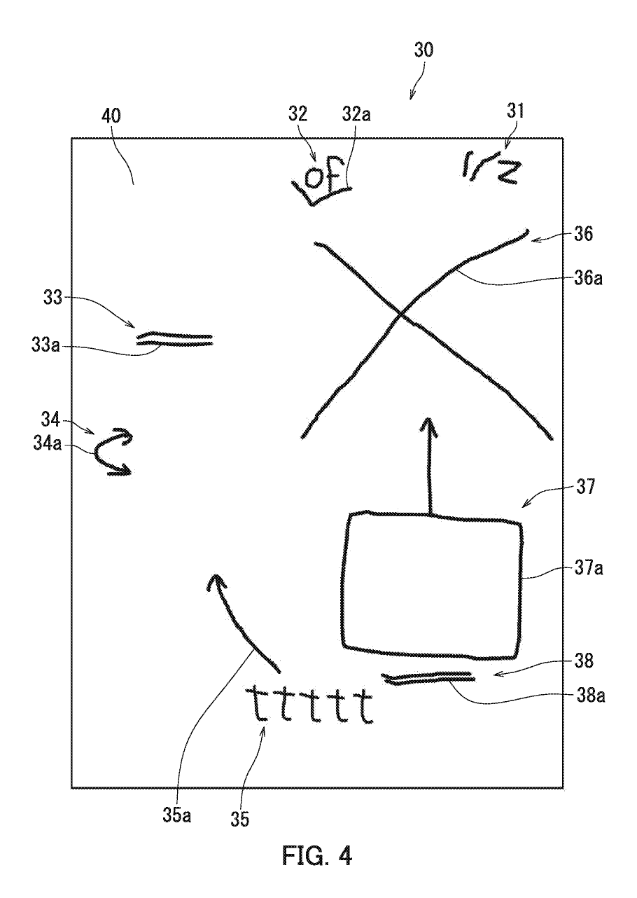

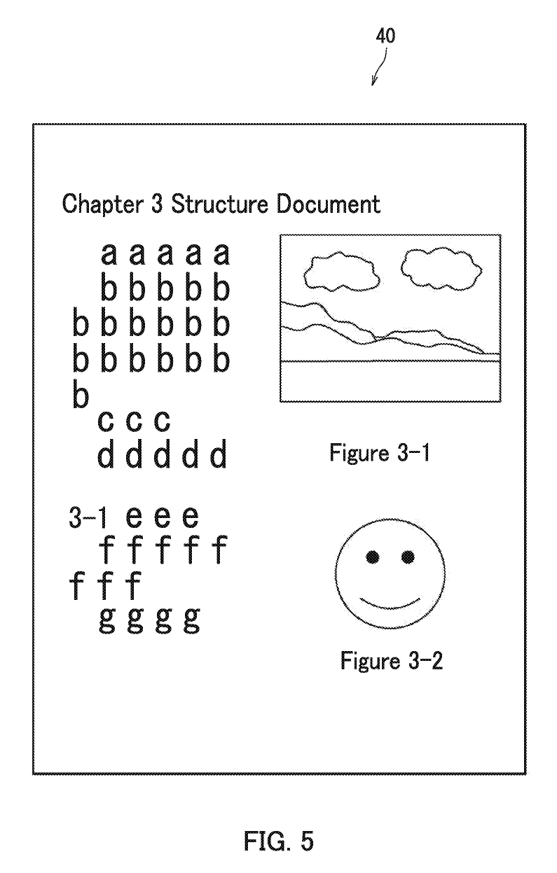

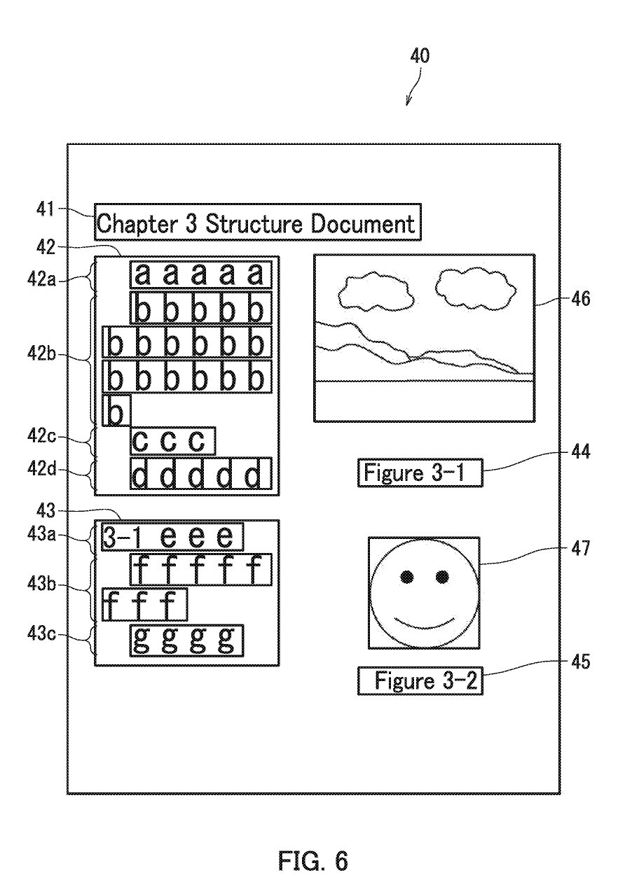

FIG. 3 is a diagram illustrating an example of an image of the markup document illustrated in FIG. 2.

FIG. 4 is a diagram illustrating an image of added handwritings in the markup document illustrated in FIG. 3.

FIG. 5 is a diagram illustrating an image of a raw original document of the markup document illustrated in FIG. 5.

FIG. 6 is a diagram illustrating the image of the raw original document illustrated in FIG. 5 divided into a plurality of areas.

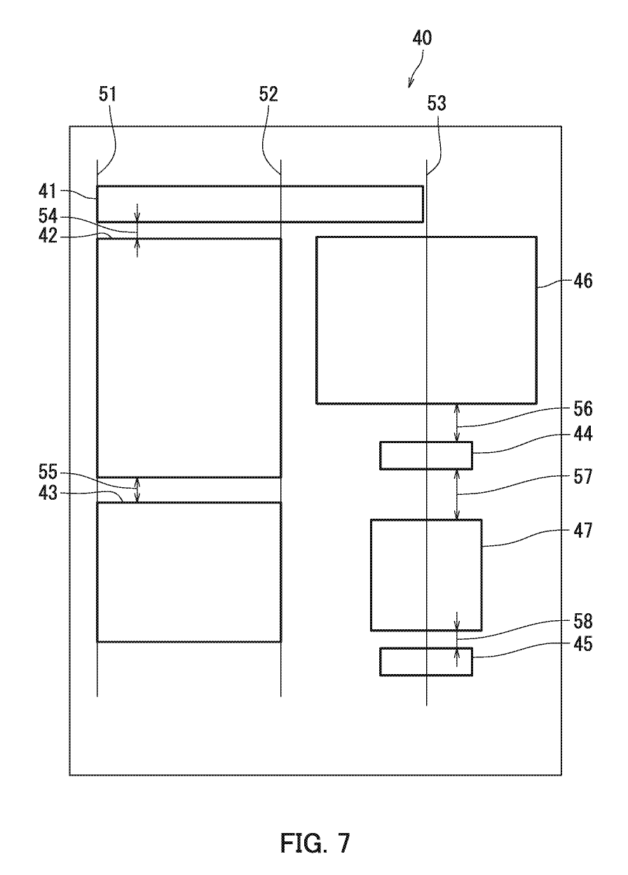

FIG. 7 is a diagram illustrating original document layout information generated from the image illustrated in FIG. 6.

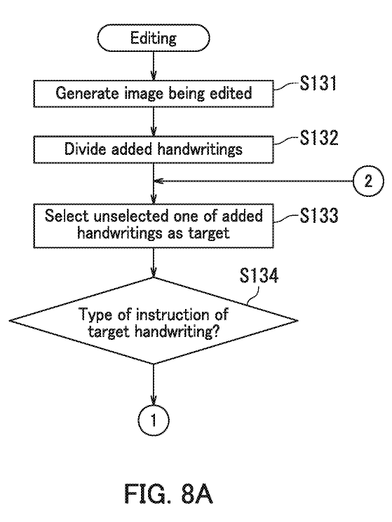

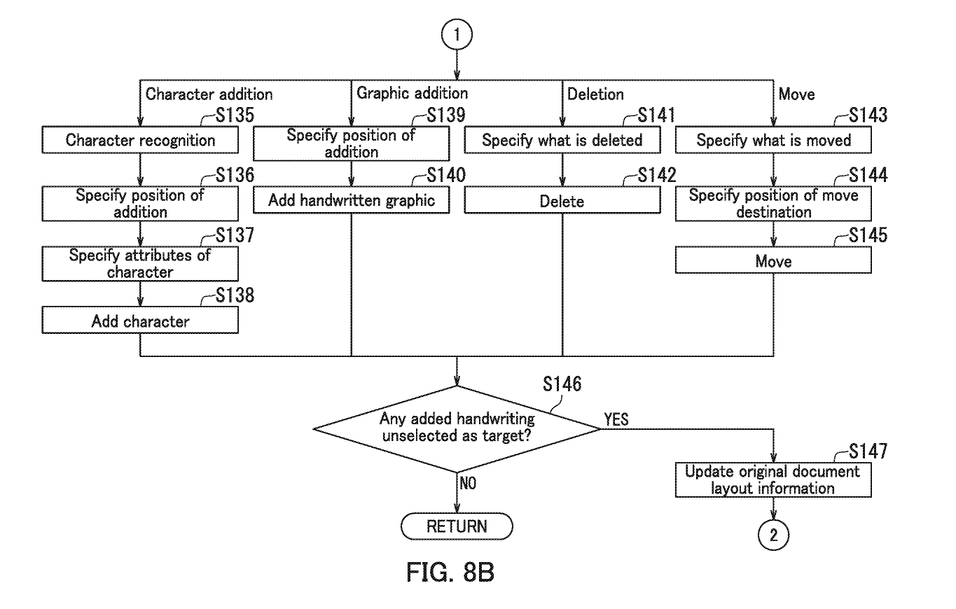

FIG. 8A is a flowchart illustrating a first half of editing illustrated in FIG. 2.

FIG. 8B is a flowchart illustrating a last half of the editing illustrated in FIG. 2.

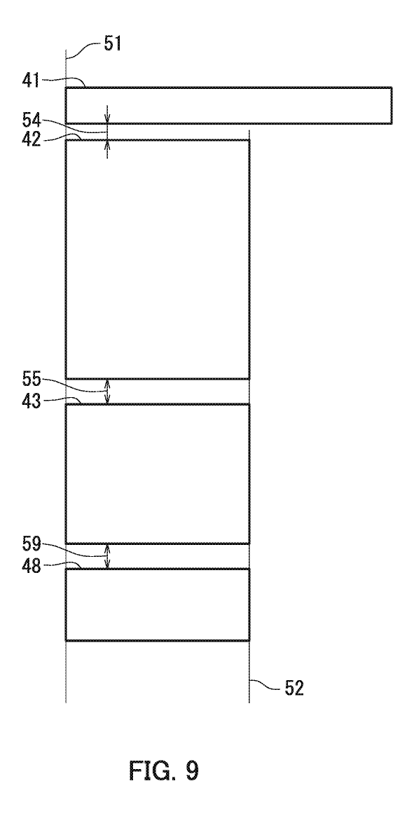

FIG. 9 is a diagram illustrating part of the original document layout information illustrated in FIG. 7 in a case where a character area is newly added.

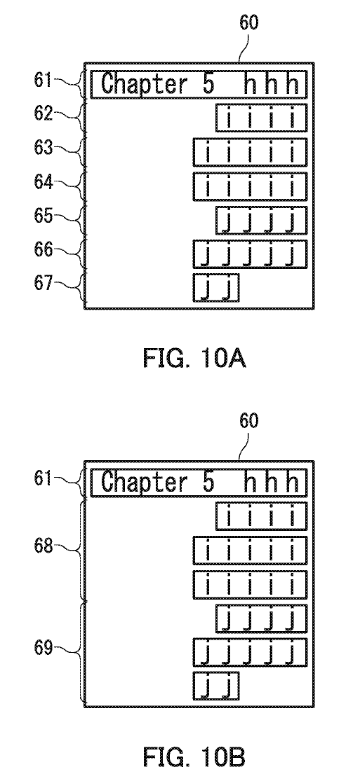

FIG. 10A is a diagram illustrating an example of an area in a case where the MFP illustrated in FIG. 1 does not recognize a “heading”.

FIG. 10B is a diagram illustrating an example of the area in a case where the MFP illustrated in FIG. 1 recognizes the “heading”.

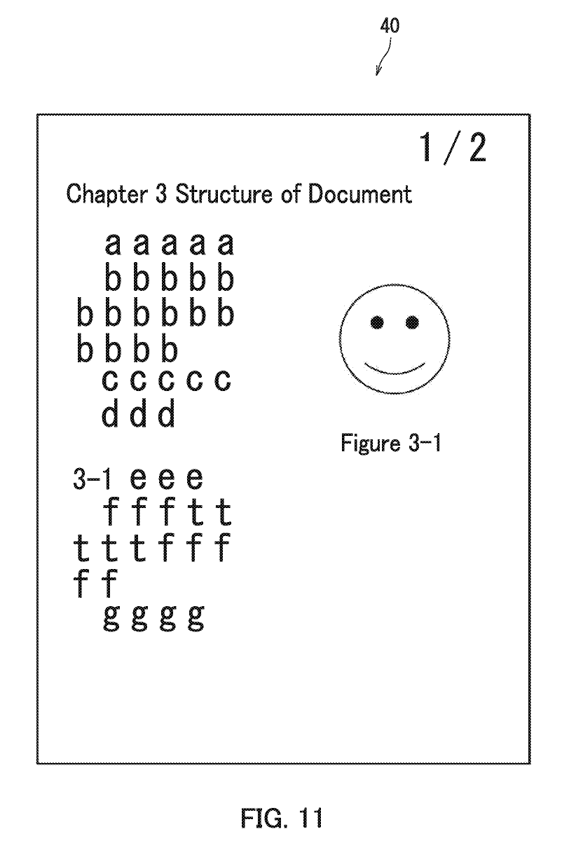

FIG. 11 is a diagram illustrating a document digitized based on the markup document illustrated in FIG. 3.

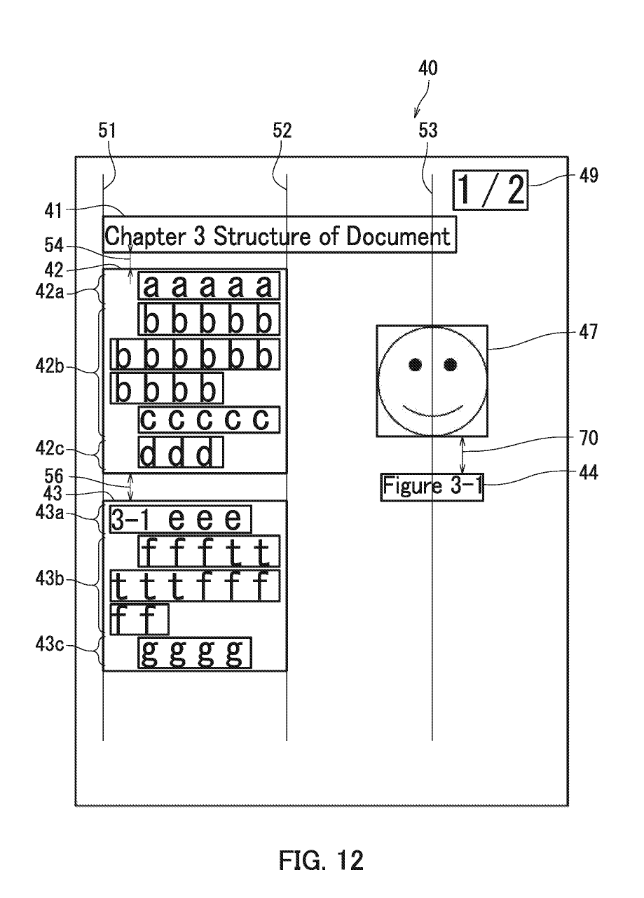

FIG. 12 is a diagram illustrating a layout of the document illustrated in FIG. 11.

### DETAILED DESCRIPTION

The following describes an embodiment of the present disclosure with the use of the drawings.

First, a configuration of a multifunction peripheral (MFP) 10 serving as an image forming apparatus according to the present embodiment will be described.

FIG. 1 is a block diagram of the MFP 10.

As illustrated in FIG. 1, the MFP 10 includes an operation section 11, a display section 12, a scanner 13, a printer 14, a fax communication section 15, a communication section 16, a storage section 17, and a controller 18. The operation section 11 is an operation device such as a set of buttons for inputting various operations. The display section 12 is a display device such as a liquid crystal display (LCD) that displays various pieces of information. The scanner 13 is a reading device that reads an image from an original document. The printer 14 is a printing device that executes printing on a recording medium such as paper. The fax communication section 15 is a fax device that performs fax communication with an external facsimile machine, not shown, via a communication line such as the public switched telephone network. The communication section 16 is a communication device that performs wired or wireless communication directly with an external device without routing the communication through a network such as a local area network (LAN) or the Internet. Alternatively, the communication section 16 is a communication device that performs communication with an external device via a network. The storage section 17 is a non-volatile storage device that stores therein various types of data, such as semiconductor memory or a hard disk drive (HDD). The controller 18 performs overall control of the MFP 10.

The storage section 17 stores therein a document digitization program 17a. The document digitization program 17a digitizes a document based on an original document modified by handwriting (hereinafter, referred to as “a markup document”) The document digitization program 17a may be installed on the MFP 10 during production of the MFP 10, or may be additionally installed on the MFP 10 from a storage medium such as an SD card and a universal serial bus (USB) memory device, or may be additionally installed on the MFP 10 from a network.

The storage section 17 can store therein specific layout information 17b indicating a specific layout. The specific layout is for example a header layout, a footer layout, and/or a column layout for text. The storage section 17 may store the specific layout information 17b for each of users of the MFP 10 or for each of groups to which users of the MFP 10 belong. The MFP 10 can learn a possible original document in advance and thereby generate the specific layout information 17b. For example, in a case where a frequency at which a user lays out original documents as two columns is greater than or equal to a specific frequency, the MFP 10 includes, in the specific layout information 17b of the user, a layout that shows the text in two columns.

The storage section 17 can store therein character attribute information 17c. The character attribute information 17c refers to character attributes such as size, font type, font weight, and distance between characters. The character attribute information 17c may refer to character attributes depending on the location of the characters, such as header, footer, and text body. The storage section 17 may store the character attribute information 17c for each of users of the MFP 10 or for each of groups to which users of the MFP 10 belong. The MFP 10 can learn a possible original document in advance and thereby generate the character attribute information 17c.

The controller 18 for example includes a central processing unit (CPU), read only memory (ROM), and random access memory (RAM). The ROM stores thereon a program and various types of data. The RAM is used as a work area of the CPU of the controller 18. The CPU of the controller 18 executes the program stored in the ROM of the controller 18 or the storage section 17.

The controller 18 implements an image acquiring section 18a, an added handwriting extracting section 18b, a raw original document reproduction section 18c, an area extracting section 18d, a layout plan determination section 18e, and a document editing section 18f by executing the document digitization program 17a stored in the storage section 17. The image acquiring section 18a acquires an image of the markup document, which is the original document modified by handwriting, using a scanner 13. The added handwriting extracting section 18b extracts handwritten modification instructions, which in other words is added handwritings, from the image of the markup document acquired by the image acquiring section 18a. The raw original document reproduction section 18c reproduces an original document without the modification by handwriting, which in other words is a raw original document, from the image of the markup document. The area extracting section 18d extracts from the raw original document each of character areas and graphic areas in the raw original document. The layout plan determination section 18e determines a layout plan of the raw original document based on the areas extracted by the area extracting section 18d. The document editing section 18f edits the raw original document of the markup document in accordance with the modification instructions given through the added handwritings extracted by the added handwriting extracting section 18b to generate a digitized document.

The following describes operation of the MFP 10 for digitizing a document based on a markup document.

FIG. 2 is a flowchart illustrating operation of the MFP 10 for digitizing a document based on a markup document.

When an instruction instructing digitization of a document based on a markup document is input via the operation section 11, the controller 18 performs a process illustrated in FIG. 2.

As illustrated in FIG. 2, the image acquiring section 18a uses the scanner 13 to read an image 20 (see for example FIG. 3) from the markup document set in the scanner 13 (S101).

FIG. 3 is a diagram illustrating an example of the image 20 of the markup document.

The image 20 illustrated in FIG. 3 has an image 40 of a raw original document and modification instructions 31 to 38 added to the raw original document by way of handwriting using a writing material in a specific color. The specific color is for example red.

The instruction 31 is an instruction to add characters “1/2” to the right end of a header.

The instruction 32 is an instruction to add characters “of” between characters “Structure” and characters “Document”. The instruction 32 includes a symbol 32a for instructing a character insertion.

The instruction 33 is an instruction to delete three characters “bbb”. The instruction 33 is made of a symbol 33a for instructing a character deletion.

The instruction 34 is an instruction to swap a line that reads “ccc” with a line that reads “ddddd”. The instruction 34 is made of a symbol 34a for instructing a line swap.

The instruction 35 is an instruction to add characters “ttttt” between characters “fff” and characters “fffff”. The instruction 35 includes a symbol 35a for instructing a character insertion.

The instruction 36 is an instruction to delete a graphic. The instruction 36 is made of a symbol 36a for instructing a graphic deletion.

The instruction 37 is an instruction to move a graphic. The instruction 37 is made of a symbol 37a for instructing a graphic move.

The instruction 38 is an instruction to delete characters “FIG. 3-2”. The instruction 38 is made of a symbol 38a for instructing a character deletion.

As illustrated in FIG. 2, after the step S101, the added handwriting extracting section 18b extracts an image 30 (see for example FIG. 4) of the added handwritings from the image 20, which is read in S101, based on the specific color (S102).

FIG. 4 is a diagram illustrating the image 30 of the added handwritings in the markup document illustrated in FIG. 3.

As illustrated in FIG. 2, after the step S102, the raw original document reproduction section 18c reproduces an image 40 (see for example FIG. 5) of a raw original document (S103). More specifically, the raw original document reproduction section 18c removes the image 30, which is extracted in S102, from the image 20, which is read in S101. It should be noted here that with respect to portions of the image 20 where the image 30 of the added handwritings is superimposed on the image 40 of the raw original document (characters and graphics), the raw original document reproduction section 18c can reproduce the color of the raw original document based on a change in the color of the added handwritings as a result of the color of the added handwritings being superimposed on the color of the raw original document. Furthermore, with respect to portions of the image 20 where the image 30 of the added handwritings is superimposed on the image 40 of the raw original document, the raw original document reproduction section 18c can complement the color of the raw original document with a surrounding color, which in other words is the color of a portion where the image 30 of the added handwritings is not superimposed on the image 40 of the raw original document.

FIG. 5 is a diagram illustrating the image 40 of the raw original document of the markup document illustrated in FIG. 3.

As illustrated in FIG. 2, after the step S103, the area extracting section 18d extracts a character area or a graphic area from the image 40 of the raw original document reproduced in S103 (S104). It should be noted here that the area extracting section 18d extracts a character area from the image 40 in a case where the image 40 has characters therein. The area extracting section 18d extracts graphic areas from the image 40 on a graphic-by-graphic basis in a case where the image 40 has graphics therein. The area extracting section 18d can extract a plurality of character areas based on a change in distance between characters and placement of a graphic area in the image 40.

FIG. 6 is a diagram illustrating the image 40 of the raw original document divided into a plurality of areas.

The image 40 illustrated in FIG. 6 is divided into character areas 41-45 and graphic areas 46-47. The area 42 includes paragraphs 42a, 42b, 42c, and 42d. The area 43 includes a heading 43a and paragraphs 43b and 43c.

As illustrated in FIG. 2, after the step S104, the layout plan determination section 18e determines whether or not the image 40 of the raw original document has character areas therein (S105).

When determining in S105 that the image 40 has character areas therein, the layout plan determination section 18e performs optical character recognition (OCR) on each of the character areas thereby to recognize characters in the character area (S106).

When determining in S105 that the image 40 has no character areas or when the step S106 is complete, the layout plan determination section 18e generates original document layout information (S107). The original document layout information indicates placement of each of the character areas and the graphic areas, which are extracted in S104, in the original document layout.

For example, the layout plan determination section 18e determines, with respect to each of the character areas and the graphic areas, a start position (a left end), a center position, and an end position (a right end) in a left-right direction of the image 40 of the raw original document as well as a start position (an upper end) and an end position (a lower end) in a top-bottom direction of the image 40 of the raw original document. In a case where some of the thus determined positions of an area and some of the thus determined positions of another area in the image 40 of the raw original document coincide, the layout plan determination section 18e determines, as the layout plan of the image 40 of the raw original document, that such areas are placed in accordance with such coinciding positions in the layout. This is because it is likely that such positions are made coincide purposely.

The layout plan determination section 18e also determines distances between areas. In a case where a distance determined for areas is shorter than a specific distance, the layout plan determination section 18e determines, as the layout plan of the image 40 of the raw original document, that the distance between the areas is maintained in the layout. The specific distance is for example a distance equivalent to two lines of characters having a specific size.

FIG. 7 is a diagram illustrating the original document layout information generated from the image 40. A distance 54 is a distance between the area 41 and the area 42. A distance 55 is a distance between the area 42 and the area 43. A distance 56 is a distance between the area 44 and the area 46. A distance 57 is a distance between the area 44 and the area 47. A distance 58 is a distance between the area 45 and the area 47.

The layout plan determination section 18e for example determines, as the layout plan of the image 40 of the raw original document, that the start positions of the areas 41 to 43 in the left-right direction are aligned as indicated by a line 51. For another example, the layout plan determination section 18e determines, as the layout plan of the image 40 of the raw original document, that the end positions of the areas 42 and 43 in the left-right direction are aligned as indicated by a line 52. For another example, the layout plan determination section 18e determines, as the layout plan of the image 40 of the raw original document, that the center positions of the areas 44 to 47 in the left-right direction are aligned as indicated by a line 53. For another example, the layout plan determination section 18e determines, as the layout plan of the image 40 of the raw original document, that all of the distances 54, 55, 56, 57, and 58 are maintained.

As illustrated in FIG. 2, after the step S107, the document editing section 18f edits (S108) the image 40 of the raw original document in accordance with the instructions given through the added handwritings, which are extracted in S102, and ends the operation illustrated in FIG. 2.

FIG. 8A is a flowchart illustrating a first half of the editing in S108. FIG. 8B is a flowchart illustrating a last half of the editing in S108.

As illustrated in FIG. 8A, the document editing section 18f makes a copy of the image 40 of the raw original document to generate an image being edited (S131).

Next, based on the image 20 read in S101 and the image 30 of the added handwritings extracted in S102, the document editing section 18f divides the added handwritings according to the distances between the added handwritings and contents of the added handwritings (S132). For example, in FIG. 4, the document editing section 18f divides the added handwritings in the image 30 into the instructions 31 to 38.

After the step S132, the document editing section 18f selects an unselected one of the added handwritings, which are divided in S132, as a target (S133).

Next, the document editing section 18f determines a type of the instruction of the currently-selected target handwriting (S134).

As illustrated in FIG. 8B, when determining in S134 that the instruction is a “character addition” such as the instruction 31, 32, or 35, the document editing section 18f recognizes all character from the currently-selected target handwriting by OCR (S135).

Next, the document editing section 18f specifies a position to which the character from the currently-selected target handwriting is to be added (S136).

More specifically, in a case where a position to which the character from the currently-selected target handwriting is to be added is appointed in a character area included in the specific layout information 17b and the original document layout information, the document editing section 18f specifies the appointed position in S136.

In a case where a position to which the character from the currently-selected target handwriting is to be added is not particularly specified in a character area included in the specific layout information 17b and the original document layout information, the document editing section 18f specifies an appropriate position in the area based on the specific layout information 17b, the document layout information, and the position of the currently-selected target handwriting in the markup document in S136. For example, in a case where the start position of the currently-selected target handwriting is located close to the start positions of separate areas that are aligned in the left-right direction of the image being edited, the document editing section 18f puts the start position of the currently-selected target handwriting in alignment with the start positions of the separate areas. Although starting positions of areas in the left-right direction of the image being edited have been described above, the same is true of center positions and end positions of areas in the left-right direction of the image being edited, and start positions and end positions of areas in the top-bottom direction of the image being edited. The document editing section 18f may separate the area of the currently-selected target handwriting from an area adjacent thereto by the same distance as the distance between areas located close to the area of the currently-selected target handwriting. If no regularity is found for the currently-selected target handwriting in terms of the start position, the center position, and the end position of the area thereof in the left-right direction of the image being edited as well as the start position and end position in the top-bottom direction of the image being edited, the document editing section 18f may specify the position of the handwriting of the currently-selected target handwriting as the position to which the character from the currently-selected target handwriting is to be added. For example, for adding a new character area 48 to a space under the area 43, the document editing section 18f defines the start position and the end position of the area 48 in the left-right direction using the line 51 and the line 52, respectively, and positions the area 48 so that a distance 59 between the area 43 and the area 48 is equal to the distance 55 between the area 42 and the area 43 as illustrated in FIG. 9.

After the step S136, the document editing section 18f specifies attributes of the character from the currently-selected target handwriting (S137). For example, in a case where the image 40 of the raw original document has an area to which the character from the currently-selected target handwriting is to be added, the document editing section 18f acquires attributes of characters located around the position in the area to which the character from the currently-selected target handwriting is to be added. The document editing section 18f then specifies the acquired attributes as the attributes of the character from the currently-selected target handwriting.

After the step S137, the document editing section 18f adds the character recognized in S135 to the position, which is specified in S136, in the image being edited with the attributes specified in S137 or with the attributes indicated by the character attribute information 17c (S138).

In a case where the position to which the character from the currently-selected target handwriting is to be added is located in the middle of an existing area, for example, the document editing section 18f adds the character from the currently-selected target handwriting to the position, and accordingly moves backward characters, among the characters in the existing area, that should follow the character from the currently-selected target handwriting by the number of added characters. The position located in the middle of an existing area is for example a position between characters in a line in a character area included in the specific layout information 17b and the original document layout information. In a case where a character is added to a paragraph in an area, and accordingly characters that should follow the added character are moved backward, the document editing section 18f maintains the paragraph after moving backward the characters. In such a case, the document editing section 18f determines a line indented in the area to be a starting line of the paragraph. Furthermore, the document editing section 18f determines a line that ends with some space, a line immediately before a starting line of a following paragraph, or a last line in the area to be an ending line of the paragraph. Furthermore, after adding the character from the currently-selected target handwriting, the document editing section 18f moves backward characters following the area including the added character as necessary by an increase in the size of the area as a result of the addition. In a case where a distance between separate areas located downward of the area including the added character is greater than a specific distance, however, a lower area of the separate areas is not moved backward until the distance between the separate areas becomes equal to the specific distance. The specific distance is for example a distance equivalent to two lines of characters having a specific size.

The document editing section 18f can recognize a “heading” line in a character area by character recognition in S106. More specifically, the document editing section 18f recognizes a specific style of for example “Chapter . . . ” and recognizes a change in character size as character recognition. In a case where paragraphs in the area that follow the “heading” are indented, therefore, the document editing section 18f can be prevented from falsely detecting that each of the lines in the area that follow the “heading” constitutes a paragraph. For example, in a case where the document editing section 18f does not recognize a line 61 in an area 60 as a “heading”, the document editing section 18f recognizes each of the following lines as a paragraph as illustrated in FIG. 10A. That is, the document editing section 18f falsely recognizes that paragraphs 62 to 67 are present as illustrated in FIG. 10A. Recognizing that the line 61 in the area 60 is a “heading”, the document editing section 18f can correctly recognize paragraphs 68 and 69 as illustrated in FIG. 10B.

When determining in S134 that the instruction is a “graphic addition”, the document editing section 18f specifies a position to which a handwritten graphic from the currently-selected target handwriting is to he added (S139).

More specifically, in S139, the document editing section 18f specifies a new layout of areas based on the specific layout information 17b, the original document layout information, and the position of the currently-selected target handwriting in the markup document. For example, if the start position of the currently-selected target handwriting is located close to the start positions of separate areas that are aligned in the left-right direction of the image being edited, the document editing section 18f brings the start position of the currently-selected target handwriting in alignment with the start positions of the separate areas. Although starting positions of areas in the left-right direction of the image being edited have been described above, the same is true of center positions and end positions of areas in the left-right direction of the image being edited, and start positions and end positions of areas in the top-bottom direction of the image being edited. The document editing section 18f may separate the area of the currently-selected target handwriting from an area adjacent thereto by the same distance as the distance between areas located close to the area of the currently-selected target handwriting. In a case where no regularity is found for the currently-selected target handwriting in terms of the start position, the center position, and the end position of the area thereof in the left-right direction of the image being edited as well as the start position and end position in the top-bottom direction of the image being edited, the document editing section 18f may specify the position of the handwriting of the currently-selected target handwriting as the position to which the handwritten graphic from the currently-selected target handwriting is to be added.

After the step S139, the document editing section 18f adds the handwritten graphic from the currently-selected target handwriting to the position, which is specified in S139, in the image being edited (S140).

After adding the handwritten graphic from the currently-selected target handwriting, the document editing section 18f for example moves downward characters and/or graphics that are located downward of an area including the added graphic as necessary by a size of the area including the added graphic.

When determining in S134 that the instruction is a “deletion” such as the instruction 33, 36, or 38, the document editing section 18f specifies a character or a graphic instructed to be deleted by the currently-selected target handwriting (S141).

Next, the document editing section 18f deletes the character or the graphic, which is specified in S141, from the image being edited (S142).

In a case where a character or a graphic in the middle of an area is to be deleted, for example, the document editing section 18f deletes the character or the graphic from the area, and accordingly moves forward characters and/or graphics that are located backward of the deleted character or graphic in the area by the extent of the deleted character or graphic. In a case where a character is deleted from a paragraph in an area, and characters and/or graphics following the deleted character are moved forward, the document editing section 18f maintains the paragraph after moving forward the characters and/or graphics. The document editing section 18f can recognize a “heading” line in a character area. In a case where paragraphs in the character area that follow the “heading” are indented, therefore, the document editing section 18f can be prevented from falsely detecting that each of the lines in the character area that follow the “heading” constitutes a paragraph. Furthermore, after deleting a character or a graphic specified in an area, the document editing section 18f moves forward areas that are located downward of the area including the deleted character or graphic as necessary by a decrease in the size of the area as a result of the deletion of the specified character or graphic.

When determining in S134 that the instruction is a “move” such as the instruction 34 or 37, the document editing section 18f specifies a character or a drawing instructed to be moved by the currently-selected target handwriting (S143).

Next, the document editing section 18f specifies a position of a move destination instructed by the currently-selected target handwriting (S144).

Next, the document editing section 18f moves the character or the graphic specified in S143 to the position, which is specified in S144, in the image being edited (S145).

In a case where the character or the graphic specified in S143 is moved to the position specified in S144, the document editing section 18f for example moves downward characters and/or graphics that are located downward of an area including the move destination as necessary by the extent of the character or the graphic specified in S143. In a case where a distance between the area including the move destination and an area that is located immediately downward of the area including the move destination is greater than a specific distance, however, the area that is located immediately downward of the area including the move destination is not moved downward until the distance between these areas becomes equal to the specific distance. The specific distance is for example a distance equivalent to two lines of characters having a specific size. In a case where the character or the graphic specified in S143 is deleted at the move destination, the document editing section 18f moves upward areas that are located downward of the area including the deleted character or graphic as necessary by the extent of the deleted character or graphic. In a case where a character is added to a paragraph in an area, and accordingly characters that should follow the added character are moved backward, the document editing section 18f maintains the paragraph after moving backward the characters. In a case where a character is deleted from a paragraph in an area, and characters and/or graphics following the deleted character are moved forward, the document editing section 18f maintains the paragraph after moving forward the characters and/or graphics. The document editing section 18f can recognize a “heading” line in a character area. In a case where paragraphs in the area that follow the “heading” are indented, therefore, the document editing section 18f can be prevented from falsely detecting that each of the lines in the area that follow the “heading” constitutes a paragraph.

After the step S138, S140, S142, or S145, the document editing section 18f determines whether or not the added handwritings divided in S132 include any added handwriting that has not been selected as a target yet (S146).

When determining in S146 that the added handwritings divided in S132 include an added handwriting that has not been selected as a target yet, the document editing section 18f updates the original document layout information (S147) and performs a step S133 illustrated in FIG. 8A.

When determining in S146 that the added handwritings divided in S132 include no more added handwriting that has not been selected as a target yet, the document editing section 18f ends the operation illustrated in FIGS. 8A and 8B.

When digitizing a document based on the markup document illustrated in FIG. 3, the MFP 10 for example performs the operation illustrated in FIG. 2 to eventually generate a document illustrated in FIG. 11 as the image being edited. The MFP 10 can then print the document illustrated in FIG. 11 using the printer 14 or store the document illustrated in FIG. 11 in the storage section 17.

FIG. 12 illustrates the layout of the document illustrated in FIG. 11. The image illustrated in FIG. 12 incorporates the following modifications compared to the image 40 of the raw original document illustrated in FIG. 6.

The characters “of” are added to the area 41 in accordance with the instruction 32. The start position of the area 41 in the left-right direction, and the start position and the end position of the area 41 in the top-bottom direction are not changed.

The three characters “bbb” are deleted from the area 42 in accordance with the instruction 33. The line including the characters “ccc” and the line including the characters “ddddd” are swapped in the area 42 in accordance with the instruction 34. The start position and the end position of the area 42 in the left-right direction, and the start position of the area 42 in the top-bottom direction are not changed. The area 42 is reduced by one line, and accordingly the end position of the area 42 in the top-bottom direction is moved upward by one line.

The characters “ttttt” are added to the area 43 in accordance with the instruction 35. The start position and the end position of the area 43 in the left-right direction, and the end position of the area 43 in the top-bottom direction are not changed. As a result of the area 42 being reduced by one line, the start position of the area 43 in the top-bottom direction is moved upward by one line.

The area 45 is deleted in accordance with the instruction 38.

The area 46 is deleted in accordance with the instruction 36.

The area 47 is moved in accordance with the instruction 37. The center position of the area 47 in the left-right direction is not changed. A distance 70 between the end position of the area 47 in the top-bottom direction and the start position of the area 44 in the top-bottom direction is equal to the distance 56 between the area 44 and the area 46 in the image 40 of the raw original document.

The characters “1/2” are added to the header in the area 49 in accordance with the instruction 31. The document editing section 18f sets the layout within the header in accordance with the specific layout information 17b.

As described above, the MFP 10 generates the digitized document by altering the position of at least some of the characters and the graphics included in the raw original document of the markup document. Thus, the adequacy of the layout of the digitized document based on the markup document can be improved.

The MFP 10 generates the digitized document by editing the raw original document in accordance with the layout plan of the raw original document. Thus, the adequacy of the layout of the digitized document based on the markup document can be improved.

When performing at least one of a character addition or a character deletion on a paragraph of the raw original document, the MFP 10 maintains the paragraph after the editing of the raw original document. Thus, the adequacy of the layout of the digitized document based on the markup document can be further improved.

The MFP 10 can reproduce the raw original document from the markup document even if the raw original document itself is not available. Thus, usability can be improved. Alternatively, the MFP 10 may store the image of the raw original document in the storage section 17 and use the image of the raw original document stored in the storage section 17 without reproducing the raw original document from the markup document.

Some steps of the document digitizing method according to the present disclosure may for example be implemented by a computer such as a personal computer (PC) instead of the MFP 10.

Although the present embodiment has been described using an example in which the image forming apparatus of the present disclosure is an MFP, the image forming apparatus may be any image forming apparatuses other than MFPs.

What is claimed is:

1. An image forming apparatus comprising:
a central processing unit (CPU);
a storage device storing therein a document digitization program; and
a reading device configured to read an image from an original document, wherein
the CPU executes the document digitization program to implement:
an image acquiring section configured to acquire an image of a markup document using the reading device, the markup document being the original document modified by handwriting;
an added handwriting extracting section configured to extract an added handwriting from the image of the markup document acquired by the image acquiring section; and
a document editing section configured to edit a raw original document in accordance with a modification instruction given through the added handwriting extracted by the added handwriting extracting section to generate a digitized document, the raw original document being the original document without the modification,
the raw original document includes one or more characters and one or more graphics, and
the document editing section alters a position of at least some of the characters and the graphics included in the raw original document to generate the digitized document.

2. The image forming apparatus according to claim 1, wherein
the CPU executes the document digitization program to further implement:
an area extracting section configured to extract areas of the characters and the graphics from the raw original document; and
a layout plan determination section configured to determine a plan of a layout of the raw original document based on the areas extracted by the area extracting section, and
the document editing section edits the raw original document in accordance with the plan determined by the layout plan determination section.

3. The image forming apparatus according to claim 1, wherein
in a case where the modification instruction is an addition of a character to a paragraph in an area of some of the characters or is a deletion of some of the characters from the paragraph, the document editing section maintains the paragraph after the editing of the raw original document.

4. The image forming apparatus according to claim 1, wherein
the CPU executes the document digitization program to further implement
a raw original document reproduction section configured to reproduce the raw original document from the image of the markup document, wherein
the added handwriting extracting section extracts the added handwriting from the image of the markup document based on a color of the added handwriting and a color of the characters and the graphics included in the raw original document, and
the raw original document reproduction section removes the added handwriting extracted by the added handwriting extracting section from the image of the markup document to reproduce the raw original document.

5. The image forming apparatus according to claim 4, wherein
with respect to a portion of the raw original document corresponding to a portion of the image of the markup document where the added handwriting is superimposed on any of the characters and the graphics included in the raw original document, the raw original document reproduction section reproduces a color of the portion of the raw original document based on a change in the color of the added handwriting.

6. The image forming apparatus according to claim 4, wherein
with respect to a portion of the raw original document corresponding to a portion of the image of the markup document where the added handwriting is superimposed on any of the characters and the graphics included in the raw original document, the raw original document reproduction section complements a color of the portion of the raw original document with a color of a portion of the image of the markup document where the added handwriting is not superimposed on any of the characters and the graphics included in the raw original document.

7. A non-transitory computer-readable storage medium storing thereon a document digitization program, wherein
the document digitization program causes an image forming apparatus to implement the following sections, the image forming apparatus including a reading device configured to read an image from an original document:
an image acquiring section configured to acquire an image of a markup document using the reading device, the markup document being the original document modified by handwriting;
an added handwriting extracting section configured to extract an added handwriting from the image of the markup document acquired by the image acquiring section; and
a document editing section configured to edit a raw original document in accordance with a modification instruction given through the added handwriting extracted by the added handwriting extracting section to generate a digitized document, the raw original document being the original document without the modification,
the raw original document includes one or more characters and one or more graphics, and
the document editing section alters a position of at least some of the characters and the graphics included in the raw original document to generate the digitized document.

8. A method for digitizing a document for implementation by an image forming apparatus including a reading device configured to read an image from an original document, the method comprising:
acquiring an image of a markup document using the reading device, the markup document being the original document modified by handwriting;
extracting an added handwriting from the image of the markup document acquired in the acquiring; and
altering a position of at least some of one or more characters and one or more graphics included in a raw original document in accordance with a modification instruction given through the extracted added handwriting to generate a digitized document, the raw original document being the original document without the modification.
